(19) United States
(12) Patent Application Publication
(10) Pub. No.: US 2013/0030871 A1
(43) Pub. Date: Jan. 31, 2013

(54) Systems, Methods, and Media for Automatically Adjusting the Prices of Products and Services Based on Consumer Demand

(71) Applicant: Zachary M. Schwitzky, Hoboken, NJ (US)

(72) Inventor: Zachary M. Schwitzky, Hoboken, NJ (US)

(21) Appl. No.: 13/560,875

(22) Filed: Jul. 27, 2012

Related U.S. Application Data
(60) Provisional application No. 61/512,317, filed on Jul. 27, 2011.

(51) Int. Cl. G06Q 30/02

(52) U.S. Cl. 705/7.35

(57) ABSTRACT

In some embodiments, a method for automatically adjusting the price of an offer, the method comprising: receiving a request to create the offer at one or more hardware processors; receiving an opening price and a minimum price for the offer; setting a current price of the offer based at least in part on the opening price; making the offer available to one or more consumers; automatically adjusting the current price of the offer based at least in part on demand for the offer, wherein demand for the offer is based at least in part on one or more variables that each reflect the measured or interest in the offer by the one or more consumers; and determining whether any of the one or more consumers has purchased the offer.

### CROSS-REFERENCE TO RELATED APPLICATION

This application claims the benefit of U.S. Provisional Patent Application No. 61/512,317, filed Jul. 27, 2011, which is hereby incorporated by reference herein in its entirety.

### TECHNICAL FIELD

The disclosed subject matter relates to systems, methods, and media for automatically adjusting the prices of commodities based on consumer demand.

### BACKGROUND

For most products and/or services, the price of a product and/or service depends at least in part on the supply of the products and/or services as well as the demand for the product and/or services by consumers. When demand for a product increases, the price for that product typically increases if the supply of the product remains constant. On the other hand, when demand for a product decreases, the price typically decreases if the supply of the product remains constant.

In many instances, individual sellers compare their prices to what other sellers are charging or look at what they themselves are paying for a product and/or service in order to set a price for their product. However, individual sellers typically do not have the ability to adjust the price that they are charging for a product and/or service in response to changes in demand, because they do not have enough information to judge changes in demand.

### SUMMARY

Systems, methods, and media for automatically adjusting the prices of products and services based on consumer demand are provided. In some embodiments, a method for automatically adjusting the price of an offer, the method comprising: receiving a request to create the offer at at least one or more hardware processors; receiving an opening price and a minimum price for the offer at the at least one or more hardware processors; setting a current price of the offer based at least in part on the opening price at the at least one or more hardware processors; making the offer available to one or more consumers, by the at least one or more hardware processors; automatically adjusting, by the at least one or more hardware processors, the current price of the offer based at least in part on demand for the offer, wherein demand for the offer is based at least in part on one or more variables that each reflect the measured or expected interest in the offer by the one or more consumers; and determining, by the at least one or more of the hardware processors, whether any of the one or more consumers has purchased the offer.

In some embodiments, a non-transitory computer-readable medium containing computer-executable instructions that, when executed by a processor, cause the processor to perform a method for automatically adjusting the price of an offer, the method comprising: receiving request to create the offer; receiving an opening price and a minimum price for the offer; setting a current price of the offer based at least in part on the opening price; making the offer available to one or more consumers; automatically adjusting the current price of the offer based at least in part on demand for the offer, wherein demand for the offer is based at least in part on one or more variables that each reflect the measured or expected interest in the offer by the one or more consumers; and determining whether any of the one or more consumers has purchased the offer.

In some embodiments, a system for automatically adjusting the price of an offer, the system comprising: at least one processor that: receives a request to create the offer; receives an opening price and a minimum price for the offer; setting a current price of the offer based at least in part on the opening price; makes the offer available to one or more consumers; automatically adjusts the current price of the offer based at least in part on demand for the offer, wherein demand for the offer is based at least in part on one or more variables that each reflect the measured or expected interest in the offer by the one or more consumers; and determines whether any of the one or more consumers has purchased the offer.

### BRIEF DESCRIPTION OF THE DRAWINGS

FIGS. 1A and 1B are examples of diagrams of user interfaces for allowing a seller to upload information about a commodity to be sold in accordance with some embodiments.

FIGS. 2A and 2B are examples of diagrams of user interfaces for presenting a confirmation page to a seller with information that was uploaded about a commodity to be sold in accordance with some embodiments.

FIG. 3 is an example of a diagram of a user interface for displaying information about a commodity and for allowing a consumer to purchase a commodity being sold by a seller or to select more options in accordance with some embodiments.

FIG. 4 is an example of a diagram of a user interface for allowing a consumer to select from a list of future purchase options in accordance with some embodiments.

FIG. 5 is an example of a diagram of hardware for performing processes and presenting user interfaces as described herein in accordance with some embodiments.

FIG. 6 is an example of a diagram of a process for selling a commodity to a consumer in accordance with some embodiments.

FIG. 7 is an example of a diagram of a process for determining if a commodity has been sold in accordance with some embodiments.

### DETAILED DESCRIPTION

In accordance with various embodiments, mechanisms for automatically adjusting the prices of products and services based on consumer demand are provided. Using these mechanisms, a product seller and/or service provider may automatically adjust the price of the commodity that is being offered for sale based at least in part on demand for the commodity. In some embodiments, demand for a commodity may be based on the number of units purchased in a certain period of time. Demand may also be based on other data such as the seller's subjectively anticipated or expected demand, or anticipated or expected demand based on an analysis of past demand for the same or similar goods, or any combination of these. A product seller may include any party that wants to offer to sell one or more units of the same or similar products. For example, a product seller may be an automobile dealer, an automobile manufacturer, a consumer electronics manufacturer, a wholesale seller, a general retailer, a specialty retailer, etc. A service provider may include any party that wants to offer to sell one or more of the same or similar services. For example, a service provider may be a hotel, an airline, a restaurant, a cleaning service, a tour operator, etc

The terms “commodity” and “commodities” are used interchangeably herein to include one or more product(s), service(s), and/or mixed goods

In some embodiments, commodities available for purchase may be presented on a Web site. The Web site may be provided over any suitable network such as the Internet, a local area network, a wide area network, a wired network, a wireless network, a telephone network, a satellite network, a cable television network, and/or any other suitable network. In some embodiments, offers to sell commodities may be on a particular portion of a Web site, or located on a particular page available from a homepage or front page of the Web site.

In some embodiments, such commodities available for purchase may be presented as part of interactive television. In some embodiments, such commodities available for purchase may be presented as part of an application downloaded and/or installed on a consumer device. In some embodiments, such commodities available for purchase may be presented as part of a kiosk display owned by a host. In some embodiments, such commodities available for purchase may be presented on any suitable display at a physical location of a seller or a third party, such as a host. In some embodiments, units of such commodities available for purchase may be stored at a physical location, if such commodities are amenable to being stored at a physical location. Such a physical location may be readily accessible to consumers, where the consumer can purchase the commodity at the location, or purchase the commodity in some other manner and pick up any purchased unit(s) of the commodity at the physical location. Alternatively, such a physical location may not be readily accessible to consumers, and units of the commodity may be shipped and/or streamed to consumers after purchase of the commodity by a consumer. Commodities available for purchase may be presented using text, images, sounds, video, and/or any other suitable form of media. The Web site, interactive television, application, kiosk, display, and/or physical location may be provided and/or maintained by a host. The host may be a seller, a consumer, both, or neither. The host may be a natural person, a business entity, a machine, or any suitable combination of these things.

In some embodiments, any suitable commodity available for purchase may have its price adjusted. Products may include tangible goods and intangible goods. Examples of a tangible good include: an automobile; a television; a satellite radio; etc. Examples of an intangible⁻good include: a song; a movie; a television show; a video game; etc. An intangible good may be stored on a computer-readable medium or streamed to a consumer device. Products may also include a mixed good where the product is bundled with a service component. Examples of a product bundled with a service component may include: a satellite radio that comes with a satellite radio service included; or an automobile that comes with roadside assistance or preventative maintenance included. Services may include intangible services. Examples of intangible services may include: cleaning; repair; legal services; teaching; etc. Services may also include a mixed good where the service is bundled with a product. Examples of a service bundled with a product may include: security monitoring that includes the equipment necessary for the monitoring; or a meal at a restaurant that includes both cooking a meal and serving the meal to a consumer as well as the food. It should be noted that many services include both tangible and intangible components, and that the word service(s) used herein is intended to cover all manner of services including any combination of tangible and/or intangible components.

In some embodiments, commodities available for purchase may be associated with a particular brand that identifies a specific business associated with a commodity. For example, GENERAL MOTORS (GM) may be a brand of automobiles that may be available for purchase and that may have its prices adjusted. As another example, SAMSUNG may be a brand of consumer electronics that may be available for purchase and that may have its prices adjusted. As another example, HILTON HOTELS may be a brand of a hotel service that may be available for purchase and that may have its prices adjusted. As another example, RUTH'S CHRIS may be a brand of a restaurant service that may be available for purchase and that may have its prices adjusted.

In some embodiments, commodities available for purchase may be associated with a particular retailer in the business of selling commodities. For example, TARGET may be a brand of a general retailer that sells a wide variety of commodities to consumers, where some selection of those commodities (up to and including all of the commodities) may be available for purchase and that may have their prices adjusted. As another example, BEST BUY may be a brand of a specialty retailer that sells a wide variety of products in a more limited variety than a general retailer such as TARGET, where some selection of those commodities (up to and including all of the commodities) may be available for purchase and that may have their prices adjusted. As another example, TICKETMASTER may be a brand of a service retailer that sells tickets for a wide variety of types of entertainment (such as concerts, sporting events, theater performances, etc.) where some selection of those services (up to and including all of the services) may be available for purchase and that may have their prices adjusted. As another example, EXPEDIA may be a brand of travel Web site retailer that may sell a wide variety of travel services (such as hotel rooms, rental cars, flights, bundled vacation packages, etc.) where some selection of those services (up to and including all of the services) may be available for purchase and that may have their prices adjusted.

In some embodiments, commodities available for purchase may be associated with a wholesale seller in the business of selling commodities. For example, a commodity sold by a wholesale seller, such as textiles or meat sold by, may be an example of a wholesale good that may be made available for purchase and may have its price adjusted.

In some embodiments, commodities may be made available for purchase to consumers. A consumer may be any suitable person, group of persons, business(es), institution(s) or other entity that buys a commodity, including an entity that is in the business of buying products or services for the purpose of reselling the products or services to consumers. In some embodiments, commodities may be made available for purchase to a limited number of consumers selected by a seller, or a limited number of consumers that are part of a pre-existing group. For example, GM may make certain automobiles available to certain automobile dealers that are in the business of selling GM automobiles. As another example, HILTON HOTELS may make certain hotel rooms available to certain travel service retailers, such as Web sites, or travel agents. As another example, a wholesale dealer may make wholesale products available to a certain group of businesses and/or people that have shown interest in buying products from the wholesaler in the past.

In some embodiments, a seller may make an offer to sell a commodity to consumers. The seller may specify an initial offer price at which the commodity will initially be offered for purchase to consumers. In some embodiments, the seller may also specify a condition based on demand, where if the condition is met the offer price is automatically increased or decreased. This condition may be based on: the total number of units sold; the number of units sold in a specific period of time; a rolling average of the number of units sold over a specified period of time; an increase or decrease in demand for a substitute for the commodity being offered; an increase or decrease in demand for a compliment to the commodity being offered; or any other suitable condition including a combination of conditions. The price increase or decrease may be: a static amount (e.g., a specific dollar amount); a percentage of the current offer price; a dynamic amount (e.g., the increase or decrease may be based on other factors aside from simply whether the condition is satisfied); or any other suitable way of setting the increase or decrease amount in relation to the condition specified by the seller.

In some embodiments, the offer price may be increased or decreased based on a variety of variables, such as: time of day; time of the month; time of the year; day of the week; location of the consumer; the weather; the opening price; the number of consumers that have shown in interest in the offer; the current price; the minimum price; the history of changes in the price of the offer; demand for compliments or substitutes to the offer; the flow of sales; or any combination of these variables with each other or with other variables. The price increase or decrease may be: a static amount (e.g., a specific) dollar amount); a percentage of the current offer price; a dynamic amount (e.g., the increase or decrease May be based on a combination of factors taking into account one or more variables); or any other suitable way of setting the increase or decrease amount in relation to the variables being used.

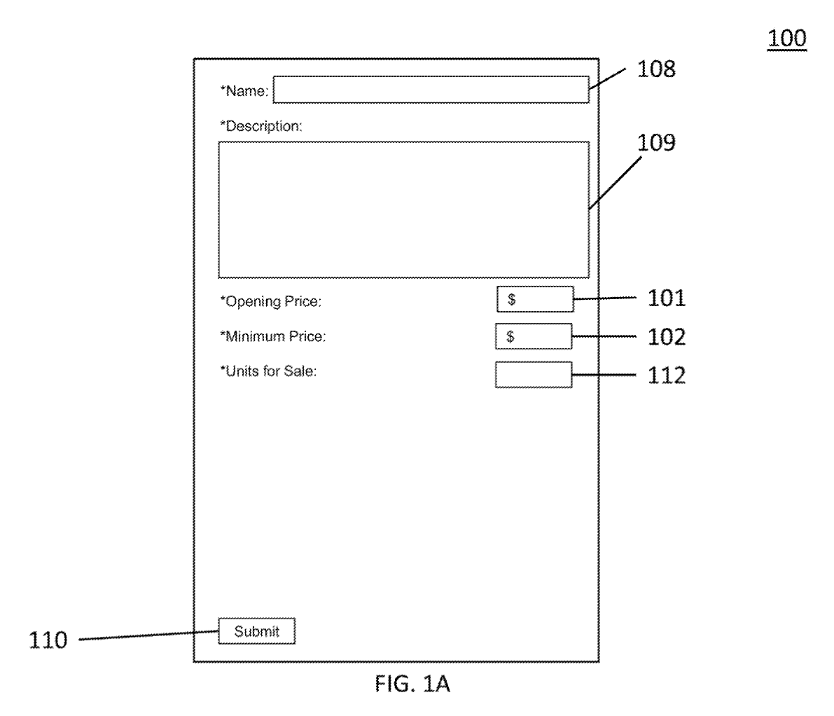

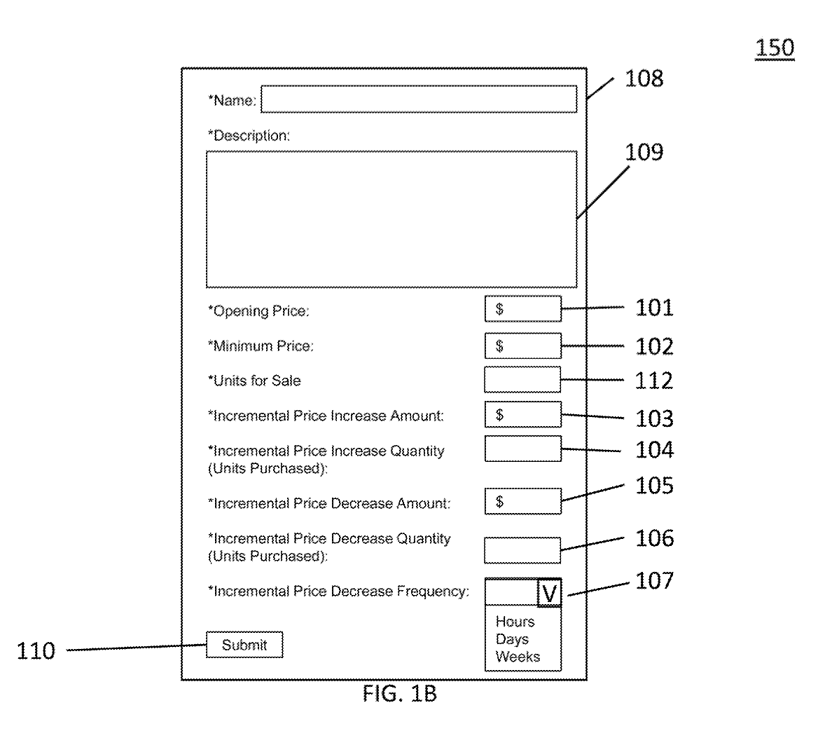

Turning to FIG. 1A, in some embodiments, a seller may upload information for a commodity available for purchase and price adjustment using seller interface 100. As shown, this interface may include fields for uploading a name 108 of the commodity, a description 109 of the commodity, an opening price 101, a minimum price 102, and a number of units for sale 112. To submit this information, the seller may select a submit option 110.

The space allowed for description 109 may be limited to a certain set number of characters (e.g., 100, 500, etc.). In some embodiments, the space allowed for the description 109 may be metered, where the seller pays for each character, for each word, each 100 characters, each 100 words, etc. In some embodiments, a predetermined amount of space may be included and a seller may be required to pay to use more space. In some embodiments, a predetermined amount of space may be included and a seller may be required to pay to use more space. In some embodiments, text, images, sounds, video, and/or any other suitable form of media may be included in description 109.

Opening price 101 and minimum price 102 may be entered in dollars. En some embodiments, opening price 101 and minimum price 102 may be entered in the local currency where the seller is located, and may be automatically converted to dollars or another suitable currency based on current exchange rates or any other suitable method for converting from one currency to another. In some embodiments, minimum price 102 may be entered as a percentage of opening price 101.

Units for sale 112 may be entered if the seller has a specified number of the same or very similar goods for sale. In some embodiments, units for sale 112 may be left blank if the units for sale are significantly different from each other. In some embodiments, the seller may enter units for sale 112 for each group of similar commodities that are part of a larger offer. In some embodiments, units for sale 112 may be left blank or eliminated if there is no set number of units for sale.

As an example, in the case of tickets to a sporting event where the tickets are assigned to seats in specific sections, opening price 101 of a ticket may vary based on section of the venue where the seat is located. In this example, the current price of a ticket may vary based on demand for seats in each section and demand for all seats at the sporting event. In such a case, units for sale 112 may be left blank, or the number of units in each section may be entered separately as units for sale and may be displayed to consumers based on the section that the consumer is currently viewing.

As another example, a seller may wish to offer a commodity for sale on an ongoing basis with no limit on the quantity that may be sold to consumers. In such a case, units for sale 112 may also be left blank.

Turning to FIG. 1B, in some embodiments, a seller may upload additional information for a commodity available for purchase and price adjustment using a seller interface 150. As shown, this interface may include fields for uploading name 108 of the commodity, description 109 of the commodity, opening price 101, minimum price 102, units for sale 112, an incremental price increase amount 103, an incremental price increase quantity 104 (in purchased units), an incremental price decrease amount 105, an incremental price decrease quantity 106 (in purchased units), and a mechanism to select the incremental price decrease frequency 107 (e.g., in seconds, minutes, hours, days, weeks, months or any other suitable length of time). To submit this information, the seller may select submit option 110

Incremental price increase amount 103 and incremental price decrease amount 105 may be entered as a flat amount (e.g., $0.50, $1.00, etc.), or as a percentage of the current price when the change takes place (e.g., 2%, 4%, etc.).

Information in fields 103-107 may be manually entered by the seller or a representative of the seller. In some embodiments, information in fields 103-107 may be automatically filled with default numbers based on the opening price and the minimum price, where the seller may or may not be able to change the default numbers.

In some embodiments, information about a commodity may be automatically filled-in to any of fields 101-109, or any combination of those fields, from a database maintained by the seller, or any suitable third party, and containing information about the commodities that the seller may offer for sale. Alternatively, information about a commodity may be automatically filled-in from any suitable information source containing the information required to sell a commodity using any suitable price adjusting mechanism. Any suitable method may be used for obtaining information from a database or another information source containing information about the commodities that a seller wants to offer for sale. The seller may be prompted to confirm that the information that was automatically filled-in is correct before the commodities are submitted for sale. Alternatively, the information that was automatically filled-in may be submitted without the seller confirming that the information is correct. The seller may be able to control how data will be entered about the commodities that they want to offer for sale. The seller may also be able to control whether they will be prompted to confirm if information has been entered correctly.

When a seller selects submit option 110, it may be determined if all of the fields are filled with valid entries. If not, the seller may be shown an error message to inform the seller that not all of the fields are filled with valid entries. Alternatively, the empty field may be automatically filled-in based on information about the seller's past behavior, information about demand, or any other suitable method for automatically filling-in the field.

In some embodiments, the seller may be able to change the quantities entered in fields 102-107 in FIGS. 1A and 1B at any time, including after the offer has been made available to consumers. In some embodiments, the seller may only be allowed to change the quantities entered in a limited number of the fields 102-107 after the offer has been made available to consumers, where the fields that may be changed may be determined by a person or organization administrating the mechanism for adjusting the price.

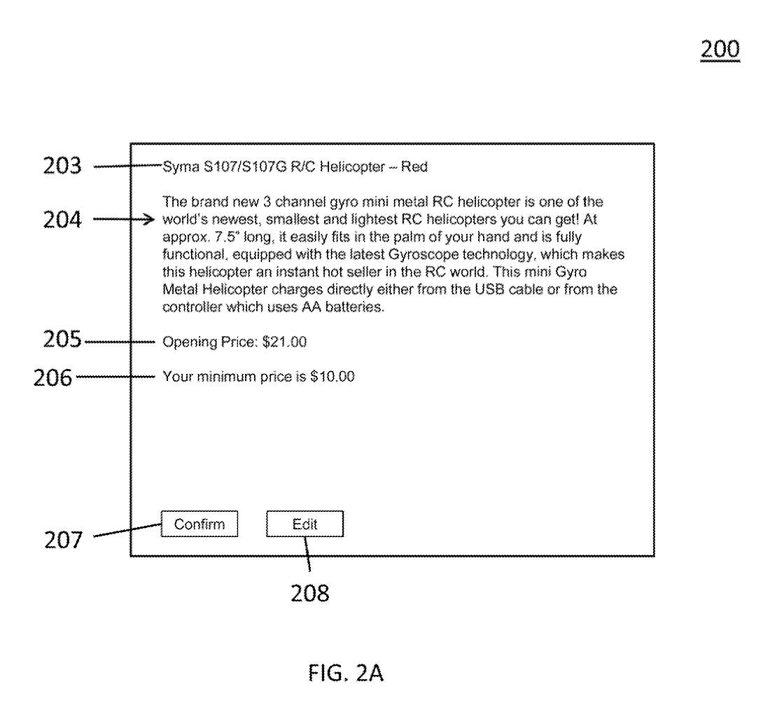

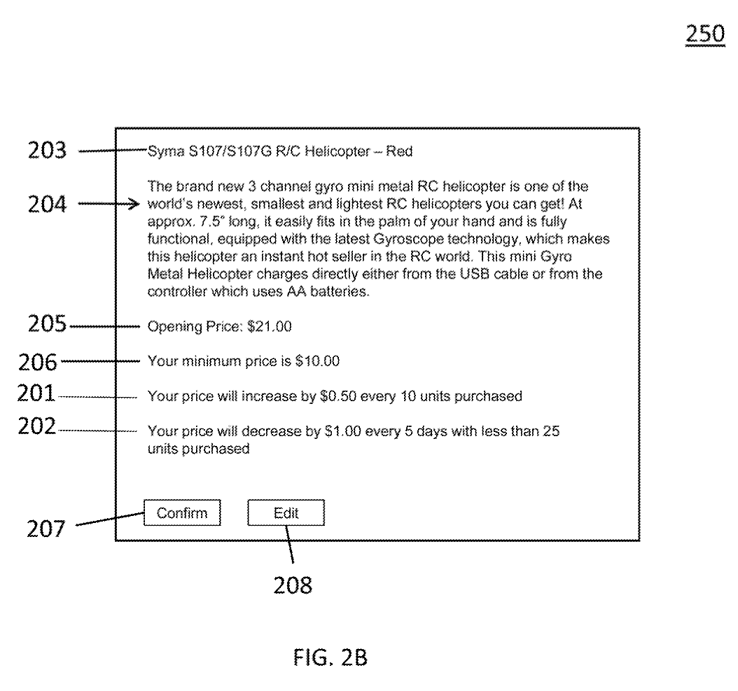

FIG. 2A illustrates an example of a confirmation page 200 based on the input fields from interface 100 or information that was automatically filled-in from an information source, such as a database. As shown, an offer name 203, a description 204, a opening price 205, and a minimum price 206 may be displayed for the seller's review. The seller may select a confirm option 207 to confirm that the displayed details are correct, or an edit option 208, which directs the seller back to interface 100 to modify one or more of the input fields.

FIG. 2B illustrates an example of a confirmation page 250 based on the input fields from interface 150 or information that was automatically filled-in from an information source, such as a database. As shown, offer name 203, description 204, opening price 205, and minimum price 206 are displayed for the seller's review. In addition, a field 201 may indicate the amount by which the price for the offer will increase for every indicated number of units purchased based on the entries in fields 103 and 104 of FIG. 1B. Similarly, field 202 may indicate the amount by which the price for the offer will decrease for each period of time indicated with less than the indicated number of units purchased based on the entries in fields 105, 106, and 107 of FIG. 1B. The seller may select confirm option 207 to confirm that the displayed details are correct, or edit option 208, which directs the seller back to interface 150 to modify one or more of the input fields.

In some embodiments, a price increase based on the number of sales and incremental price increase quantity 104 may be based on the total number of sales from the time the offer was made available to consumers. In some embodiments, a price increase based on the number of sales and incremental price increase quantity 104 may be based on the number of sales from the time when the price was last changed. Using the numbers of FIG. 2B as an example, the price may be increased by $0.50 every ten sales from the time the offer was made available to consumers. As another example, the price may be increased by $0.50 when ten sales have been made since the price was last increased or decreased, where the count may be reset whenever there is a price increase or decrease.

In some embodiments, a price decrease based on incremental price decrease quantity 106 and incremental price decrease frequency 107 may be based on the number of sales over the period of time specified in field 107. The number of sales may be checked only when an entire period has elapsed (e.g., every five days), or the number of sales may be checked on a rolling basis (e.g., the previous five days of sales may be checked every day). Taking the numbers from FIG. 2B as an example, the price may decrease when there have been less than 25 sales over five days, where a price decrease is checked for every five clays from when the offer is made available to consumers. In an alternative example, the price may decrease whenever there have been less than 25 sales over the five days before the current day, where a price decrease is checked for every day, every other day, etc.

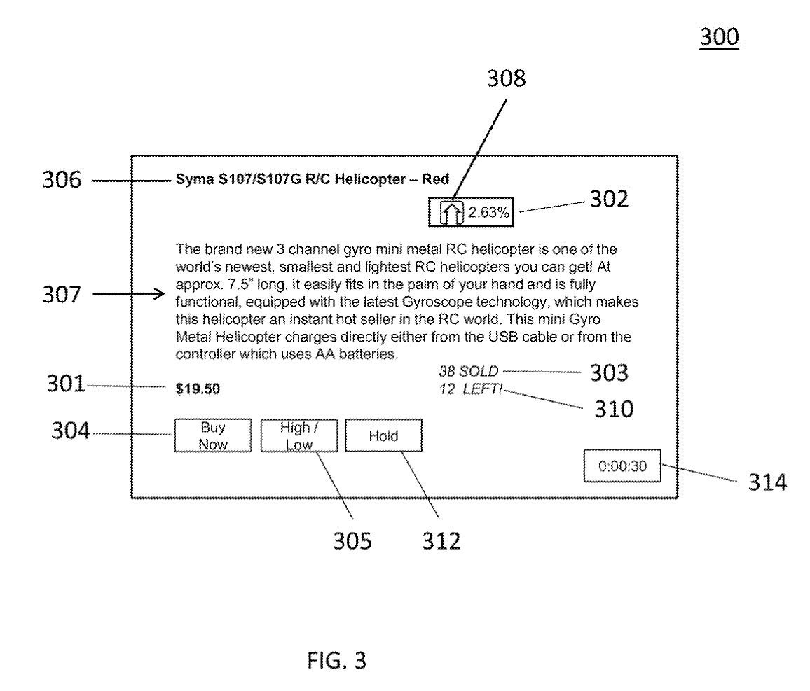

As shown in FIG. 3, in some embodiments, a consumer may purchase a commodity available for purchase using a consumer interface 300. As illustrated, a name 306, a description 307, a current price 301, a percentage price change 302, a number of units purchased 303, a number of units remaining 310, a buy now option 304, a high/low option 305, and a hold option 312 may be displayed.

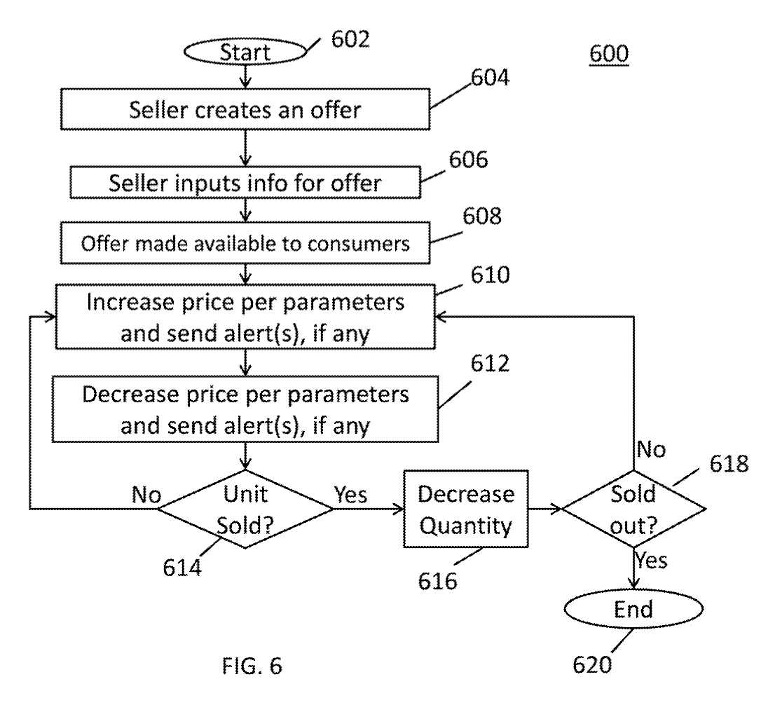

Current price 301 shown to the consumer may be the price at which the consumer may purchase the commodity using buy now option 304. In some embodiments, the current price may be automatically adjusted based on a process that takes into account one or more variables used to approximate actual and/or expected demand for the commodity being sold. An example of a process for automatically adjusting the price is discussed with reference to FIG. 6. In some embodiments, the current price may be automatically adjusted based on the values entered in fields 103-107 of FIG. 1B and based on demand for the commodity. In some embodiments, current price 301 may include sales tax, a value added tax (VAT), shipping, handling, and/or any other suitable fees. In some embodiments, sales tax, a value added tax (VAT), shipping, handling, and/or any other suitable fees may be displayed to the consumer and added to current price 301 if and when the consumer commits to purchasing the offer.

In various embodiments, current price 301 at which the consumer may purchase the offer may be fixed or changed periodically. The following are various examples of how current price 301 offered to the consumer may be presented. Current price 301 may be fixed at the price when the consumer first viewed the offer. Current price 301 may change in real-time whenever the price is recalculated based on demand, or any other factor. Every predetermined amount of time (for example, one minute, one hour, etc.), it may be determined if there has been a change in the price, and current price 301 may be changed to the new price if there has been a price change. The user interface may timeout without informing the consumer and the consumer may be prompted to refresh the offer in a case where the consumer attempts to select buy now option 304, high/low option 305, or hold option 312.

In some embodiments, the consumer may be shown a countdown 314 of how much time is left until the price may change. Optionally, the consumer may be required to pay a fee to have countdown 314 displayed. Such a fee may be a flat amount or may be based on current price 301. In some embodiments, hold option 312 may be displayed to a consumer that allows the consumer to prevent the price from changing for a predetermined amount of time. Optionally, the consumer may be required to pay a fee to use hold option 312. Such a fee may be a flat amount or may be based on current price 301. Countdown 314 may be used in conjunction with hold option 312 to display to the consumer how much of the consumer's hold is remaining. In some embodiments, the number of consumers that may select hold option 312 may be limited. For example, the number of consumers that may select hold option 312 may be limited to 125 consumers, or any other suitable number. If a 126th consumer wants to select hold option 312, they may be not be allowed to do so, or they may be required to pay a fee. Such a fee may take the form of an increase in a fee charged for use of hold option 312, as either a flat amount or based on current price 301.

Percentage price change 302 may be automatically adjusted each time current price 301 is automatically adjusted, using the formula:

Percentage Price Change=(Price Change Amount/Price Before Adjustment).

An up arrow 308 may be displayed adjacent to percentage price change 302 when the current price has increased. A down arrow (not shown) may be displayed adjacent to percentage price change 302 when current price 301 has decreased. In some embodiments, percentage price change 302 may be given as a change over a certain time period (e.g., minutes, hours, days, etc.). Alternatively, the percentage price change may be presented graphically as a change over time, in either absolute terms (e.g., a dollar amount) or in percentages from a specified time (e.g., from this time yesterday, from this time last year, from when the offer was first made, etc.). In some embodiments, presentation of percentage price change 302 may be fixed, or the seller or consumer may be able to choose a preferred presentation of percentage price change 302.

The consumer may purchase the commodity available for purchase by selecting buy now option 304. Units purchased 303 may display the number of units purchased over a specified period of time, or from some event. For example, units purchased 303 may display the total units purchased from when the commodity was first offered. As another example, units purchased 303 may display the units purchased over the last day, week, month, etc. As another example, units purchased 303 may display the units purchased from some event, such as when the commodity went on sale, when the last price change occurred, or any other suitable event. Units purchased 303 may be automatically increased whenever there is a purchase. This may be done dynamically while a consumer is viewing the offer, or it may be fixed while a consumer is viewing the offer, or any combination of the two (e.g., the units purchased may update periodically).

In some embodiments, units remaining 310 may display the number of units that the seller has remaining to sell. Units remaining 310 may always be displayed or may be displayed only when units remaining 310 is less than a threshold number. Units remaining 310 may automatically decrease whenever there is a purchase. This may be done dynamically while a consumer is viewing the offer, or it may be fixed while a consumer is viewing the offer, or any combination of the two (e.g., the units purchased updates periodically).

When the consumer selects high/low option 305, they may be directed to interface 400.

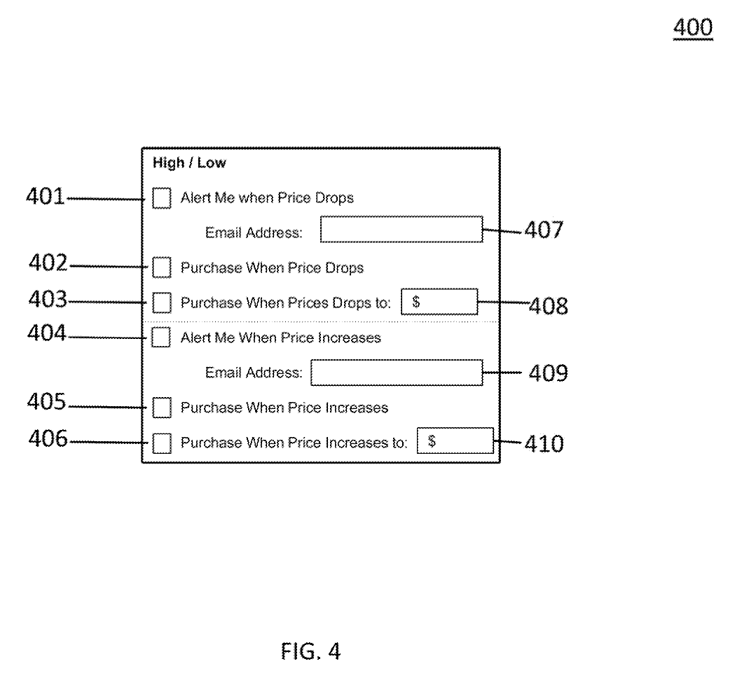

As illustrated in FIG. 4, in some embodiments, the consumer may then select from a list of future purchase options using interface 400. The input fields provide a consumer the ability to automatically purchase or receive updates when current price 301 drops and/or increases. Interface 400 may include options 401-406, email address input fields 407 and 409, and input fields 408 and 410. In some embodiments, the consumer may select to be alerted when the price drops using an option 401, to purchase when the price drops using option 402, and/or to purchase when the price drops to a price entered in field 408 using option 403. In some embodiments, the consumers may select to be alerted when the price increases using option 404, to purchase when the price increases using option 405, and/or to purchase when the price increases to a price entered in field 410 using option 406.

In some embodiments, if the user selects option 401 or 404 alerts may be issued based on any price drop or increase accordingly, or only on a price drop or increase by a certain amount, or by a certain amount compared to current price 301 (e.g., a percentage change). The alert may be issued to a consumer only the first time the condition specified by the consumer occurs. Alternatively, the alert may be issued each time the condition specified occurs. In another alternative the consumer may be given an option to continue receiving alerts or to stop receiving alerts each time the consumer receives such an alert.

In some embodiments, a seller may elect to make any or all of options 401-406 available to consumers. In some embodiments, the seller may have no control over whether consumers are able to select options 401-406. In some embodiments, a seller may be required to pay a fee in order to make options 401-406 available to consumers. Such a fee may be a flat amount (e.g., $0.50, $1.00, etc.) or may be based on current price 301 when the consumer selects one of options 401-406 or any combination of options 401-406 (e.g., a percentage of current price 301 when the consumer selects an option). Alternatively, such a fee may be based on current price 301 at which a sale to a consumer is actually completed.

When a consumer selects option 401, the consumer may be asked to enter their email address in email address input field 407. The consumer may then receive an alert when current price 301,decreases. By selecting option 401, the consumer may be prevented from selecting option 402 and/or option 403.

When selecting option 402, a purchase of the commodity may be automatically completed as requested by the consumer; when current price 301 decreases. By selecting option 402, the consumer may be prevented from selecting option 401 and/or option 403.

When selecting option 403, the consumer may enter a price below the current price in input field 408. If and when current price 301 reaches the price the consumer entered in field 408, a purchase of the commodity may be automatically completed as requested by the consumer. By selecting option 403, the consumer may be prevented from selecting option 401 and/or option 402. In some embodiments, the consumer may enter a percentage decrease or an amount decrease (e.g., −$0.50 or −$10) in field 408, rather than a nominal price (e.g., $2.25 or $400). In some embodiments, there may be a minimum and/or maximum amount that the consumer is allowed to enter in field 408. For example, the price or amount entered may be required to be at least 1% lower than the current price, or at least $0.50 lower than the current price, etc. Alternatively, there may be no limits on the price or amount that may be entered in field 408.

When selecting option 404, the consumer may be asked to enter their email address in email address input field 409. The consumer may then receive an alert when current price 301 increases. By selecting option 404, the consumer may be prevented from selecting option 405 and/or option 406.

Although email address was used with respect to fields 407 and 409, the consumer may be asked to enter any unique identifier that supports receiving messages with an alert, such as a phone number where the user may receive a message, an instant messenger name, a SKYPE NAME, a FACEBOOK page, etc. In some embodiments, after a consumer enters the contact information, a confirmation may be sent to the consumer that requires the consumer to respond and confirm that they requested to be alerted. Such a response may take any suitable form.

When selecting option 405, a purchase of the commodity may be automatically completed as requested by the consumer, when current price 301 increases. By selecting option 405, the consumer may be prevented from selecting option 404 and/or option 406.

When selecting option 406, the consumer may enter a price above the current price in input field 410. If and when current price 301 reaches the price the consumer entered in field 410, a purchase of the commodity may be automatically completed as requested by the consumer. By selecting option 406, the consumer may be prevented from selecting option 404 and/or option 405. In some embodiments, the consumer may enter a percentage increase or an amount increase (e.g., +$0.50, +$10, ten dollars, etc.) in input field 410, rather than a nominal price (e.g., $2.25 or $400). In some embodiments, there may be a minimum and/or maximum amount that the consumer:is allowed to enter in field 410. For example, the price or amount entered may be required to be at least than 1% higher than the current price, or at least $0.50 higher than the current price. Alternatively, there may be no limits on the price or amount that may be entered in field 410.

In some embodiments, if a consumer selects buy now option 304, or any of options 402, 403, 405 or 406, or any combination of these options, then the consumer may be required to enter delivery and/or billing information. In some embodiments, delivery information may include a physical address, a post office box, a location for electronic delivery, or any other suitable delivery information. In some embodiments, billing information may include a bank account number, a credit card number, a billing address, a PAYPAL account, or any other suitable information that would allow the consumer to be billed for a purchase.

In some embodiments, a consumer may be allowed to select one of options 401-403 and one of options 404-406. In some embodiments, the consumer may be charged a fee before they are allowed to select any of options 401-406. Such a fee may be a flat amount (e.g., $0.50, $1.00, etc.) or may be based on current price 301.

In some embodiments, the number of consumers that may select options 402 and/or 405 may be limited. For example, for a given current price, the number of consumers that may select option 402 and/or 405 may be limited to 125, or any other suitable number.

In some embodiments, the number of consumers that may select a given price in options 403 and/or 406 may be limited. For example, the number of consumers that may enter a price that is $1.00 less than the current price may be limited to 125 consumers, or any other suitable number. If a 126th consumer wants to purchase the offer when the price decreased, they may be required to enter a different amount. In some embodiments, the amounts that may be entered in fields 408 and 410 may be limited to whole dollars, or some other fixed amount different than the current price, or it may be any price that a consumer enters. In some embodiments, restrictions on the number of consumers allowed to reserve an item may be based on a range of prices that are different than the current price. Taking the example above and applying it to these embodiments, the number of consumers that may enter a price between $0.01 and $1.00 less than the current price may be limited to 125, or any other suitable number.

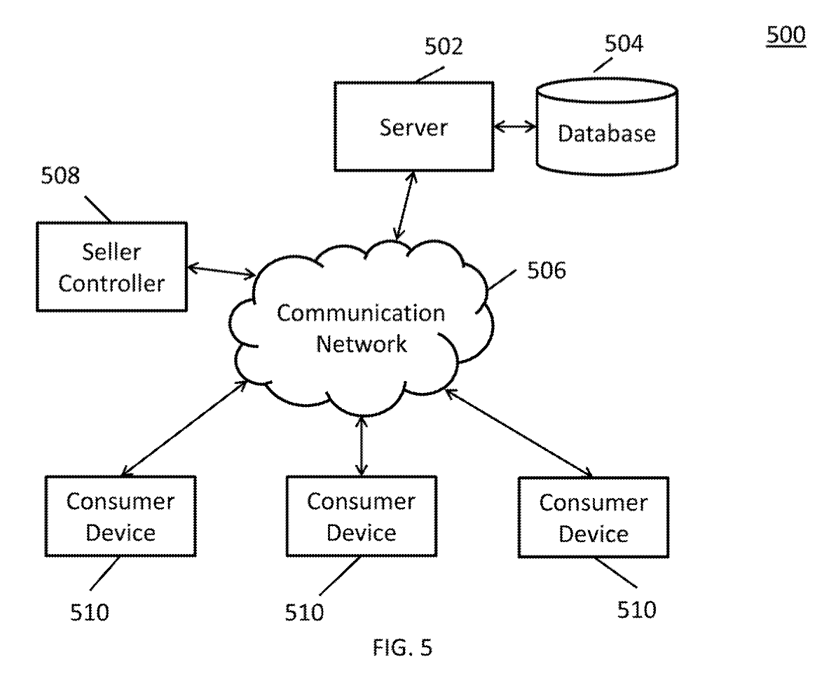

Turning to FIG. 5, an example of hardware 500 that may be used to implement some embodiments may include a server 502, a database 504, a communication network 506, a seller controller 508, and consumer devices 510. Server 502 may be any suitable general or special purpose computer for controlling the processes described herein, controlling the presentation of displays, storing any suitable data, etc.

Database 504 may be any suitable hardware and/or software for providing database functions such as storing data, finding data, providing data, etc., and database 504 may be separate from or part of server 502. In some embodiments, any suitable data may be stored in database 504.

Any suitable number of servers 502 and/or databases 504 (including zero) may be provided in some embodiments.

Communication network 506 may be any suitable network or combination of networks for communicating data. For example, network 506 may include the Internet, a local area network, a wide area network, a wired network, a wireless network, a telephone network, a satellite network, a cable television network, and/or any other suitable network.

Seller controller 508 may be any general or special purpose computer for controlling the presentation of a commodity available for purchase by one or more sellers. Although only one seller controller is illustrated, any suitable number (including zero) of seller controllers may be included in some embodiments.

Consumer devices 510 may be any suitable general or special purpose computers for providing a user interface for presenting and interacting with commodities available for purchase as described above. For example, any of consumer devices 510 may be implemented as a personal computer, a personal data assistant (PDA), a portable email device, a multimedia terminal, a mobile telephone, a set-top box, a television, a game console, a kiosk, an in-store display, any of the preceding devices owned by someone other than the consumer, etc.

Any of these general or special purpose devices or computers may include any suitable components such as a hardware processor (which may be a microprocessor, digital signal processor, a controller, etc.), memory, communication interfaces, display controllers, input devices, etc.

In some embodiments, any suitable computer readable media may be used for storing instructions for performing the processes described herein. For example, in some embodiments, computer readable media may be transitory or non-transitory. For example, non-transitory computer readable media may include media such as magnetic media (such as hard disks, floppy disks, etc.), optional media (such as compact discs, digital video discs, Blu-ray discs, etc.), semiconductor media (such as flash memory, electrically programmable read only memory (EPROM), electronically erasable programmable read only memory (EEPROM), etc.), any suitable media that is not fleeting or devoid of any semblance of permanence during transmission, and/or any suitable tangible media. As another example, transitory computer readable media may include signals on networks, in wires, conductors, optical fibers, circuits, any suitable media that is fleeting and devoid of any semblance or permanence during transmission, and/or any suitable intangible media.

In accordance with some embodiments, an example process 600 that may be used in accordance with some embodiments is shown. As illustrated, after the process starts at 602, the seller creates an offer at 604. An offer may be for a commodity available for purchase. At 606, the seller may input any suitable information for the offer, such as the offer name, a description, an opening price, a minimum price and/or parameters for price adjustments based on number of purchased units and time. This may be done manually by the seller, or by a party representing the seller entering information into a seller interface, as shown in the example of FIG. 1A or 1B. Alternatively, the information may be filled-in automatically by the seller exporting information from an information source available to the seller that contains the necessary information for carrying out the rest of the process of 600. In another alternative embodiment, the information may be automatically filled-in by a host (as discussed above) by importing information from an information source specified by the seller, or any suitable third party, that contains the necessary information for carrying out the rest of the process of 600. At 608, the offer is made available to consumers. At 610, it is determined whether current price 301 should be increased, and if a price increase is warranted, the price may be automatically increased. Any suitable alerts to be generated based on the price increase may also be generated at 610. At 612, it is determined whether current price 301 should be decreased, and if a price decrease is warranted, the price may be automatically decreased. Any suitable alerts to be generated based on the price decrease may also be generated at 612. Next, at 614, it may be determined if a unit of the offer was sold. If it is determined at 614 that no unit was sold (“no” at 614), process 600 may loop back to 610. If it is determined at 614 that a unit was sold (“yes” at 614), process 600 may decrease the quantity available of the offer at 616. At 618, process 600 may determine if the offer is sold out. If not, the process may loop back to 610. Otherwise the process may end at 620.

Determining whether a price increase is warranted at 610 or weather a price decrease is warranted at 612 may be done in any suitable manner. For example, current price 301 may be a function of the sales volume of the offer over a certain period of time (“sales volume over time” or “SV”) and the last price (“LP,” e.g., the price before adjustment to the current price), where the period of time specified may depend on the nature of the commodity being offered and the opening price. Current price 301 may be increased if the sales volume over time is greater than the average sales volume over time (AvgSV), by a specified amount (including zero). Current price 301 may be decreased if the sales volume over time is less than the average sales volume over a specified period of time, by a specified amount (including zero), where current price 301 may not be decreased below the minimum price. In some embodiments, the price may not be increased or decreased if the difference between the sales volume over time and the average sales volume over time is less than some specified amount. For example, if the difference is less than 1%, then the price may be left unchanged. The initial value for the average sales volume overtime may be: defined by the seller based on the sellers past experience; based on average sales volume over time of the same product when it was offered for sale in the past; based on the average sales volume of a similar product; set at a default value based on opening price 101, units for sale 112, or any other suitable variable; or any combination of these. In some embodiments, the average sales volume over time may be calculated based on the actual sales of the offer over time, or the initial value of average sales volume over time may be gradually changed as data about the actual sales is collected. In some embodiments, the current price may be calculated by using the following formula:

Current Price=LP+LP((SV−AvgSV)/AvgSV).

In some embodiments, the amount by which the price is adjusted may be influenced by any of a variety of secondary variables, or any combination of the secondary variables. The secondary variables and any constants used to normalize the secondary variables may collectively act as a weight W I, for determining a magnitude of a price change in response to sales volume over time compared to average sales volume over time. Secondary variables may include:

A product of the previous price and the time since the last price adjustment (LP*t(LA));

A ratio of the minimum price to last price adjustment (MP/LP);

A ratio of the current price to the last price adjustment (CP/LA);

A ratio of the current price to the minimum price (CP/MP);

A ratio of the current price to the opening price (CP/OP);

A ratio of the opening price to the minimum price (OP/MP);

A ratio of the opening price to the last price adjustment (OP/LA);

A ratio of the opening price to sales volume (OP/SV); and

The Time since the last price adjustment over a specified time (t(LA)/T).

In some embodiments, the current price may be calculated by using the following formula:

Current price=LP+LP*((SV−AvgSV)/AvgSV)*W1,

where W1 represents the combined effect of the one or more secondary variables, combined with any constants for normalizing the secondary variables. 100761 In some embodiments, the product of the previous price and the time since the last price adjustment (LP*t(LA)) may be used to determine how much the price should be adjusted, as it may indicate how frequently the price changes. A relatively small value indicates that the last price was small, or the time between adjustments is large. A relatively large value indicates that the price was large or that the time between adjustments is small. In some embodiments, LP*t(LA) may be normalized such that a value over 1 indicates a larger magnitude of a price change, and a value less than 1 indicates a smaller magnitude of a price change.

In some embodiments, the ratio of the minimum price to last price adjustment (MP/LP) may be used to determine how much the price should be adjusted, as it may indicate how much room there is to change the price. A relatively large value may indicate that the last price adjustment was relatively small compared to the average price. A relatively small value may indicate that the last price adjustment was relatively large compared to the minimum price. In some embodiments, LA/MP may be normalized such that a value greater than 1 indicates a larger magnitude of a price change, and a value less than 1 indicates a smaller magnitude of a price change.

In some embodiments, the of the current price to the last price adjustment (CP/LA) may be used to determine how much the price should be adjusted, as it may indicate the rate of change of the price. A relatively large value may indicate that the last price change was small compared to the current price. A relatively small value may indicate that the last price change was large compared to the current price. In some embodiments, CP/LA may be normalized such that a value greater than 1 indicates a larger magnitude of a price change, and a value less than 1 indicates a smaller magnitude of a price change

In some embodiments, the ratio of the current price to the minimum price (CP/MP) may be used to determine how much the price should be adjusted, as it may indicate how much room there is to change the price. A relatively large value may indicate there is a lot of room to decrease the price, and therefore a price decrease should be made larger. A relatively small value may indicate there is not a lot of room to decrease the price, and therefore a price decrease should be made smaller. Conversely, a relatively large value may indicate that the price is relatively high and a price increase should be made smaller, and a relatively small value may indicate that the price is relatively low and a price increase should be made larger. In some embodiments, CP/MP may be normalized such that a value greater than 1 indicates a larger magnitude price decrease and a smaller magnitude price increase, and a value less than 1 indicates a smaller magnitude price decrease and a larger magnitude price increase.

In some embodiments, the ratio of the current price to the opening price (CP/OP) may be used to determine how much the price should be adjusted, as it may indicate how far the current price is from the opening price. In some embodiments, if the current price is close to the opening price, then the magnitude of price changes may be made larger, and if the current price is far from the opening price, then the magnitude of price changes may be made smaller. This ratio may also be used as the ratio of the absolute value of the difference between the current price and the opening price over the opening price.

In some embodiments, the ratio of the opening price to the minimum price (OP/MP) may be used to determine how much the price should be adjusted, as it may indicate the range over which the price may adjust. A relatively small value may indicate that the range over which the price may adjust is small, and therefore the magnitude of price changes should be smaller than otherwise indicated. A relatively large value may indicate that the range over which the price may adjust is large, and therefore the magnitude of price changes should be larger than otherwise be indicated. In some embodiments, OP/MP may be normalized such that a value greater than 1 indicates a larger magnitude of a price change, and a value less than 1 indicates a smaller magnitude of a price change.

In some embodiments, ratio of the last price adjustment to the opening price (OP/LA) may be used to determine how much the price should be adjusted, as it may indicate how far the last price was from the opening price. A relatively large value may indicate that the last adjustment was small and the price is close to the opening price, whereas a relatively small value may indicate that the last adjustment was large and the price is far from the opening price, whereas. In some embodiments, OP/LA may be normalized such that a value greater than 1 indicates a larger magnitude of a price change, and a value less than 1 indicates a smaller magnitude of a price change.

In some embodiments, the ratio of the opening price to sales volume (OP/SV) may be used to determine how much the price should be adjusted, as it may indicate the margins underlying the offer. A high ratio may indicate a high offer price, low sales volume, or both. A low ratio may indicate a low offer price, high sales volume or both. A relatively large ratio may indicate an offer with a high margin and/or low volume and causes the magnitude of price changes to be larger. A relatively small ratio may indicate an offer with a small margin and/or high volume and causes the magnitude of price changes to be smaller. In some embodiments, OP/SV may be normalized such that a value greater than 1 indicates a larger magnitude of a price change, and a value less than i indicates a smaller magnitude of a price change.

In some embodiments, the time since the last price adjustment may be used to determine how much the price should be adjusted, as it may indicate volatility of demand. If the volume of sales is relatively steady, there may be few price changes, and if the volume of sales is inconsistent, there may be more frequent price changes. If the time between adjustments is relatively long, the magnitude of price adjustments may be made larger to respond to long term changes in demand with larger adjustments. If the time between adjustments is relatively short, then the magnitude of price adjustments may be made smaller to be less sensitive to short term fluctuations in demand that may not be driven by price. In some embodiments, the time between adjustments may be normalized such that a value greater than 1 indicates a larger magnitude of a price change, and a value less than 1 indicates a smaller magnitude of a price change.

In some embodiments, the sales volume over time may be influenced by any of a variety of tertiary variables, or any combination of the variety of tertiary variables. These variables and any constants used to normalize the secondary variables may collectively act as a weight W2, for adjusting the sales volume that may be used in determining if a price increase or a price decrease is warranted. Tertiary variables may include:

The effect of weather on expected, current, and/or historical demand;

The effect of current events on expected, current, and/or historical demand;

The time of day;

The day of the week;

The month of the year;

The number of consumers that have shown interest in the offer;

The location of the consumer; and

Commitments by consumers to purchase the offer at a given price

In some embodiments, the current price may be calculated by using the following formula:

Current price=LP+LP*((SV*W2−AvgSV)/AvgSV)*W1,

where W1 represents the combined effect of the one or more secondary variables, combined with any constants for normalizing the secondary variables, and W2 represents the effect of the one or more tertiary variables, combined with any constants for normalizing the tertiary variables.

In some embodiments, the effect of weather related events on demand may be used to adjust sales volume of an offer based on the likely effect of the weather related event on demand, and/or the measured effect of the weather related event on current and/or historical demand. For example, an impending hurricane may cause demand for electric generators or other supplies used by consumers expecting to be impacted by a hurricane to increase by a large amount. If not taken into account when adjusting the price, this may appear to be simply an increase in demand, which causes the price of certain offers to go up faster than is otherwise warranted. In some embodiments, if demand for an offer is likely to increase when there is a specific type of weather related event, sales volume may be adjusted to take this into account and not increase the price too quickly when demand spikes in response to a weather related event. Information regarding whether demand for an offer is likely to be impacted by a weather related event may be entered by the seller, or may be generated automatically based on the type of commodity being offered.

In some embodiments, the effect of current events on demand may be used to adjust sales volume of an offer based on the likely effect of the current event on demand, and/or the measured effect of the weather related event on current and/or historical demand. For example, demand for apparel related to the winner of the championship game in a sports tournament may increase following the championship game. In some embodiments, a current event that increases demand may be taken into account by increasing the sales volume to take advantage of the increase in demand for the offer when it may be most lucrative. As another example, an earthquake may increase demand for certain commodities such as generators, but a seller may not want to increase price in response to such an increase in demand because it may cause harm to the seller's reputation. Therefore, in some embodiments, certain current events may cause sales volume to decrease to suppress changes in price in response these current events.

In some embodiments, the time of day may be used to determine expected demand and adjust sales volume accordingly. For example, if movies playing at 7 pm historically have higher demand, the sales volume for movie tickets for the 7 pm movie may be adjusted over the sales volume for the rest of the day to take advantage of the higher demand by adjusting prices more quickly for historically popular time slots. In another example, demand for tickets to a baseball game may become more popular in the two hours before the game starts, based on historic behavior of ticket sales. Here the sales volume may be increased over the last two hours to take advantage of the higher demand in the last few hours before the event.

In some embodiments, the day of the week may be used to determine expected demand and adjust sales volume accordingly. For example, if, historically, demand for movie tickets is higher for movies that are showing on Friday or Saturday, sales volume during those times may be adjusted over the volume for the rest of the week to take advantage of the higher demand on those days.

In some embodiments, the month of the year may be used to determine expected demand and adjust sales volume accordingly. For example, if demand swimwear is higher in the Spring and Summer, then sales volume may be increased going into the Spring to take advantage of the higher expected demand and may be decreased near the end of Summer to decrease the price to try to sell as much of the remaining stock of swimwear while consumers are still interested.

In some embodiments, the number of consumers that have shown interest in the offer by, for example, viewing the offer, selecting the alert when price decreases option 401, selecting the alert when price increases option 404, and/or selecting hold option 312 may be used to determine demand and adjust sales volume accordingly. For example, if more consumers are viewing the offer but not buying the offer that may indicate interest in the offer at a lower price than current price 301, or it may indicate interest in the offer at a later time when the consumer has more need of the offer. As another example, a large number of consumers selecting the alert when price decreases option 401 may indicate interest in the offer, but a desire to wait until the price goes down to purchase the offer. As another example, a large number of consumers selecting the alert when price increases option 404 may indicate interest in the offer. This information may be used to adjust the sales volume to increase or decrease the price based on other indicators of interest. In some embodiments, any other measurement of consumer interest may be used to determine demand and adjust sales volume accordingly.

In some embodiments, the location of the consumer viewing the offer may be used to determine expected demand and adjust sales volume accordingly based on the proximity of the consumer to a current event or weather related event. For example, information on the location of the consumer may be used by itself or in conjunction with other tertiary variables to determine expected demand and adjust sales volume accordingly. For example, in the event of a hurricane in one area, demand for certain offers may be expected to increase in that area which may appear as an increase in demand. As discussed previously, it may not be desirable to increase prices of offers to consumers impacted by a hurricane so the consumers location combined with information about the hurricane may be used to suppress price increases for consumers affected by the hurricane. At the same time, consumers in locations that may not be affected by the hurricane may have the same offer made available to them at rapidly increasing prices based on the increase in demand due to the hurricane.

As another example, in the event of a terrorist attack in a city in the United States, demand for firearms may increase in the entire United. States and even into other countries where consumers may consume news related to the United States. In such a case, the proximity of the consumer to the city where the attack took place may not be as important and sales volume may be adjusted for all consumers that have access to news about the United States. Determining an area over which to adjust sales volume may be based on whether the current event or weather related event is a local event, a regional event, a national event, a global event, or any other suitable demarcation of area. 100951 In some embodiments, the number of consumers that have committed to buying the offer at a price other than the current price may be used to determine demand and adjust sales volume accordingly to influence the current price. For example, if a large number of consumers select option 402 to purchase the offer when the price drops, but few consumers are using buy now option 304, this may indicate that the price is too high and the price may be adjusted accordingly. As another example, if a large number of consumers are selecting the purchase when price drops option 402 and the purchase when price increases option 405, this may indicate that a large number of consumers are interested in the offer, but are expecting the price to fall so they want to wait to purchase the offer. This may be interpreted as increased demand for the offer and may be used to increase the sales volume.

In some embodiments, current price 301 may be based on the parameters entered in fields 103-107. For example, if the number of sales has increased by the number specified by the seller per the parameters input by the seller at 606, the price may be increased by the amount specified by the seller at 606. If the number of sales over a predetermined amount of time (e.g., seconds, minutes, hours, weeks, days or months) falls below a threshold specified by the seller per the parameters input by the seller at 606, the price may be decreased by the amount specified by the seller at 606.

For example, if the amounts were as specified in FIG. 2B, and the number of sales has increased by ten, the current price may be increased by $0.50. This may be done on the basis of total sales, or it may be done on the basis of the number of sales since the last price adjustment. If the number of sales were less than 25 over the last five days, the price may be decreased by $1.00. This may be done every five days, or it may be recalculated every day based on the last five days.

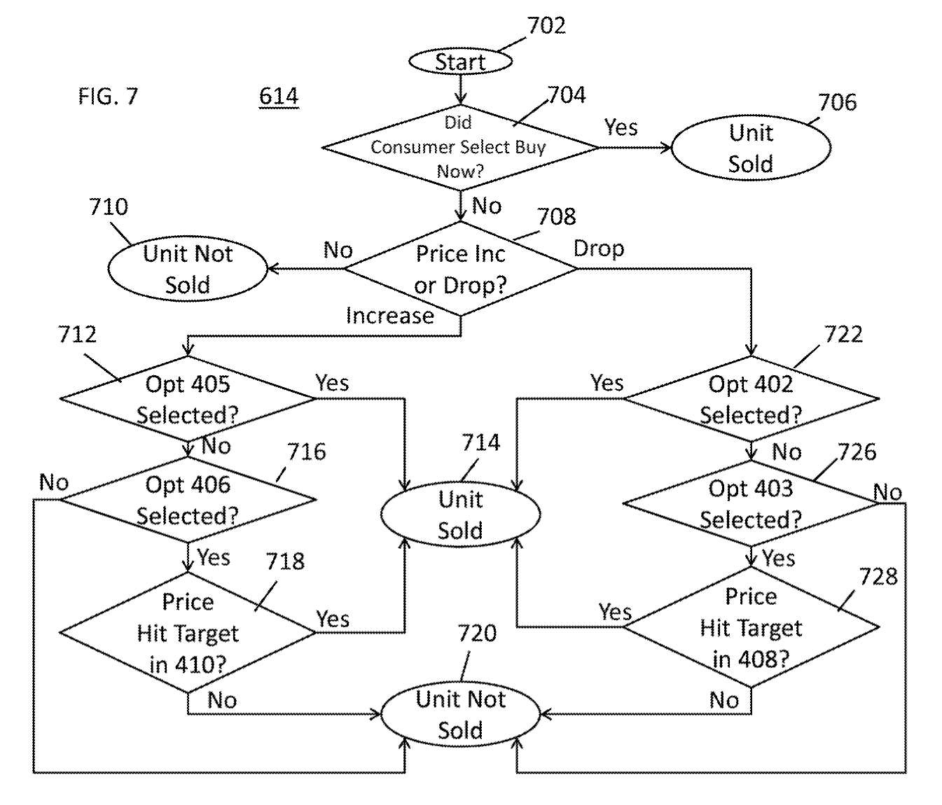

FIG. 7 illustrates an example process 614 for determining if a unit has been sold. As shown, after the process begins at 702, the process may determine at 704 whether the consumer selected the buy-now option to purchase the offer at the current offer price. If so, then a unit is considered sold, and the process terminates at 706. Otherwise, the process determines at 708 if there has been a price increase, a price decrease (or price drop), or neither. If neither, then a unit is not considered sold, and the process terminates at 710.

If the price increased, then it may be determined at 712 if option 405 (FIG. 4) was selected. If so, then a unit is considered sold, and the process terminates at 714. Otherwise, it may be determined at 716 if option 406 (FIG. 4) was selected, and if so, it may be determined at 718 whether the price hit the target in 410 (FIG. 4). If so, then a unit is considered sold, and the process terminates at 714. If the determinations at either of 716 and 718 is no, then a unit is not considered sold, and the process terminates at 720.

If the price decreased, then it may be determined at 722 if option 402 (FIG. 4) was selected. If so, then a unit is considered sold, and the process terminates at 714. Otherwise, it may be determined at 726 if option 403 (FIG. 4) was selected, and if so, it may be determined at 728 whether the price hit the target in 408 (FIG. 4). If so, then a unit is considered sold, and the process terminates at 714. If the determinations at either of 726 and 728 is no, then a unit is not considered sold, and the process terminates at 720.

In some embodiments, the seller may also act as the host. In some embodiments, the seller may pay a fee to the host. The fee may be a percentage of sales, a flat fee on each sale, or a flat fee.

Although dollars were used as an example of currency throughout this disclosure, it is recognized that any suitable currency may be used and the currency displayed to different sellers and/or consumers may be based on their preferences and/or location.

Although the invention has been described and illustrated in the foregoing illustrative embodiments, it is understood that the present disclosure has been made only by way of example,.and that numerous changes in the details of implementation of the invention may be made without departing from the spirit and scope of the invention, which is limited only by the claims that follow. Features of the disclosed embodiments may be combined and rearranged in various ways.

What is claimed is:

1. A method for automatically adjusting the price of an offer, the method comprising:
receiving a request to create the offer at at least one or more hardware processors;
receiving an opening price and a minimum price for the offer at the at least one or more hardware processors;
setting a current price of the offer based at least in part on the opening price at the at least one or more hardware processors;
making the offer available to one or more consumers, by the at least one or more hardware processors;
automatically adjusting, by the at least one or more hardware processors, the current price of the offer based at least in part on demand for the offer, wherein demand for the offer is based at least in part on one or more variables that each reflect the measured or expected interest in the offer by the one or more consumers; and
determining, by the at least one or more of the hardware processors, whether any of the one or more consumers has purchased the offer.

2. The method of claim 1, wherein demand for the offer is further based on the number of times the offer has been purchased by consumers over a predetermined amount of time.

3. The method of claim 1, further comprising:
receiving, by the one or more hardware processors, from a consumer device an instruction to complete a purchase of the offer by a consumer that is a user of the consumer device if the current price is automatically adjusted; and
automatically completing, by the one or more hardware processors, the purchase of the offer by the user of the consumer device if the current price is automatically adjusted.

4. The method of claim 1, further comprising:
receiving, by the one or more hardware processors, an instruction from a consumer device to complete a purchase of the offer by a consumer that is a user of the consumer device if the current price is automatically adjusted by more than a predetermined amount received from the consumer device; and
automatically completing the purchase of the offer by the user of the consumer device if the current price is automatically adjusted by more than the predetermined amount.

5. The method of claim 1, further comprising:
receiving, by the one or more hardware processors, a number of units for sale, wherein automatically adjusting the current price is repeatedly carried out after the determining until all units have been sold.

6. The method of claim 1, further comprising:
receiving, by the one or more hardware processors, an instruction from a consumer device to send an alert to a consumer that is a user of the consumer device if the price changes; and
sending an alert to the user of the consumer device if the price changes.

7. The method of claim 1, wherein the receiving further comprises:
automatically receiving, by the one or more hardware processors, the opening price and the minimum price from a database specified by a seller.

8. A non-transitory computer-readable medium containing computer-executable instructions that, when executed by a processor, cause the processor to perform a method for automatically adjusting the price of an offer, the method comprising:
receiving a request to create the offer;
receiving an opening price and a minimum price for the offer;
setting a current price of the offer based at least in part on the opening price;
making the offer available to one or more consumers;
automatically adjusting the current price of the offer based at least in part on demand for the offer, wherein demand for the offer is based at least in part on one or more variables that each reflect the measured or expected interest in the offer by the one or more consumers; and
determining whether any of the one or more consumers has purchased the offer.

9. The medium of claim 8, wherein demand for the offer is further based on the number of times the offer has been purchased by consumers over a predetermined amount of time.

10. The medium of claim 8, wherein the method further comprises:
receiving from a consumer device an instruction to complete a purchase of the offer by a consumer that is a user of the consumer device if the current price is automatically adjusted; and
automatically completing the purchase of the offer by the user of the consumer device if the current price is automatically adjusted.

11. The medium of claim 8, wherein the method further comprises:
receiving an instruction from a consumer device to complete a purchase of the offer by a consumer that is a user of the consumer device if the current price is automatically adjusted by more than a predetermined amount received from the consumer device; and
automatically completing the purchase of the offer by the user of the consumer device if the current price is automatically adjusted by more than the predetermined amount.

12. The medium of claim 8, wherein the method further comprises:
receiving a number of units for sale, wherein automatically adjusting the current price is repeatedly carried out after the determining until all units have been sold.

13. The medium of claim 8, wherein the method further, comprises:
receiving an instruction from a consumer device to send an alert to a consumer that is a user of the consumer device if the price changes; and
sending an alert to the user of the consumer device if the price changes.

14. The medium of claim 8, wherein the method further comprises:
automatically receiving the opening price and the minimum price from a database specified by a seller.

15. A system for automatically adjusting the price of an offer, the system comprising:
at least one processor that:
receives a request to create the offer;
receives an opening price and a minimum price for the offer;
sets a current price of the offer based at least in part on the opening price;
makes the offer available to one or more consumers;
automatically adjusts the current price of the offer based at least in part on demand for the offer, wherein demand for the offer is based at least in part on one or more variables that each reflect the measured or expected interest in the offer by the one or more consumers; and
determines whether any of the one or more consumers has purchased the offer.

16. The system of claim 15, wherein demand for the offer is further based on the number of times the offer has been purchased by consumers over a predetermined amount of time.

17. The system of claim 15, wherein the processor is further configured to:
receive from a consumer device an instruction to complete a purchase of the offer by a consumer that is a user of the consumer device if the current price is automatically adjusted; and
automatically complete the purchase of the offer by the user of the consumer device if the current price is automatically adjusted.

18. The system of claim 15, wherein the processor is further configured to:
receive an instruction from a consumer device to complete a purchase of the offer by a consumer that is a user of the consumer device if the current price is automatically adjusted by more than a predetermined amount received from the consumer device; and
automatically complete the purchase of the offer by the user of the consumer device if the current price is automatically adjusted by more than the predetermined amount.

19. The system of claim 15, wherein the processor is further configured to:
receive a number of units for sale, wherein automatically adjusting the current price is repeatedly carried out after the determining until all units have been sold.

20. The system of claim 15, wherein the processor is further configured to:
receive an instruction from a consumer device to send an alert to a consumer that is a user of the consumer device if the price changes; and
send an alert to the user of the consumer device if the price changes:

21. The system of claim 15, wherein the processor is further configured to:
automatically receive the opening price and the minimum price from a database specified by a seller.
